(19) United States
(12) Patent Application Publication
(10) Pub. No.: US 2010/0241686 A1
(43) Pub. Date: Sep. 23, 2010

(54) METHOD, SYSTEM AND DEVICE FOR IMPLEMENTING MEDIA NEGOTIATION

(75) Inventors: Rong Deng, Shenzhen (CN); Xuefie Song, Shenzhen (CN); Qian Sun, Shenzhen (CN); Hao Wang, Shenzhen (CN); Jiangtao Jia, Shenzhen (CN)

Correspondence Address: Docket Clerk/HTCL, P.O. Drawer 800889, Dallas, TX, 75380, US

(73) Assignee: Huawei Technologies Co., Ltd.

(21) Appl. No.: 12/790,485

(22) Filed: May 28, 2010

Related U.S. Application Data
(63) Continuation of application No. PCT/CN2008/073262, filed on Nov. 28, 2008.

(30) Foreign Application Priority Data
Nov. 29, 2007 (CN) 200710195812.6

(51) Int. Cl. G06F 15/16

(52) U.S. Cl. 709/202

(57) ABSTRACT

A method, a system, and a device for implementing media negotiation are provided. The method includes the following steps. A caller sets media levels, and sends a request carrying the media levels to a callee. After receiving a response carrying media selected by the callee according to the media levels returned from the callee, the caller performs corresponding processing according to the media selected by the callee. Through the method, the caller sets primary and optional media types and specifies the levels of each media type during the media negotiation process. Thus, the additional media information improves the efficiency of the media negotiation of a session.

### CROSS-REFERENCE TO RELATED APPLICATIONS

This application is a continuation of International Application No. PCT/CN2008/073262, filed on Nov. 28, 2008, which claims priority to Chinese Patent Application No. 200710195812.6, filed on Nov. 29, 2007, both of which are hereby incorporated by reference in their entireties.

### TECHNICAL FIELD

The present disclosure relates to the technical field of communications, and more particularly to a method, system, and device for implementing media negotiation.

### BACKGROUND

With the convergence of the mobile communication network and the Internet Protocol (IP) network and the development of the next generation network, all session services will support multimedia session. Media negotiation between entities is indispensable during a multimedia session. Through the media negotiation, the entities reach an agreement on the media type combination and the coding scheme used by each medium in the current session.

The media negotiation between the entities can be implemented through a Session Description Protocol (SDP) Offer/Answer mechanism. The SDP is an application layer protocol for describing multimedia session, and the SDP Offer/Answer mechanism is used by the entities to reach an agreement on the description of a specific session.

In the SDP Offer/Answer mechanism, when an entity intends to create a session, the entity may generate an SDP session description, which is referred to as an offer. The offer contains a set of media streams and a set of coding schemes that an offerer intends to use, and a destination IP address and a destination port that the offerer intends to use for sending the media. An answerer generates an SDP answer corresponding to the received offer. The answer carries information about whether to accept the media stream, the coding scheme to be used, and a destination IP address and a destination port that the answerer desires to use for sending the media. After the answer to the first offer is received, the offerer may generate subsequent offers through the same Offer/Answer mechanism. However, an offer can be generated only after the answer to the previous offer is received. The two parties negotiate through the Offer/Answer mechanism described above until the agreement on the media type combination and the coding scheme used by each medium is reached for the session, and thus, the session is established successfully.

FIG. 1 shows a media negotiation process of an existing Session Initiation Protocol (SIP) multimedia session. The process includes the following steps.

In Step S101, a caller sends an INVITE request carrying a first SDP offer to a callee. The SDP offer lists all media types that the caller intends to use in a current session and coding types supported by the different media through a series of media description lines.

The SDP message contains three levels of information, namely, session-level description, time-level description, and media-level description. The media description lines belong to the media-level description. A session description may contain a number of media description lines, and each media description line contains four sub-fields: media type, port number, transmission protocol, and format list.

In Step S102, after receiving the INVITE request, the callee returns a first SDP answer according to the SDP offer carried in the INVITE request. In the SDP answer, some suggested media types may be rejected, and the coding scheme list may be shrunk by omitting the unsupported types while reserving the coding schemes supported by both parties. In addition, the media description of the caller must be completely consistent with that of the callee, that is, an n^{th} media description line in the session description of the caller must be corresponding to the n^{th} media description line in the session description of the callee. If the callee does not want to send nor receive a media stream offered by the caller, the port number of the media stream is set to zero in the session description. For example, the media description lines contained in the INVITE request of the caller are shown as follows:

m=audio 49170 RTP/AVP 0

m=video 51372 RTP/AVP 31

m=video 53000 RTP/AVP 32

The media description lines indicate that the caller intends to establish a session with the callee in the form of one audio stream and two video streams. After receiving the INVITE request sent by the caller, the callee returns an answer message, and the media description lines in the SDP part of the answer message are shown as follows:

m=audio 47920 RTP/AVP 0

m=video 0 RTP/AVP 31

m=video 53000 RTP/AVP 32

The callee sets the port number of the second media description line to zero, indicating that the callee does not accept the video stream.

In Step S103, after receiving the first SOP answer, the caller determines whether to accept the media type selected by the callee. If the caller determines to accept the media type selected by the callee, Step S104 is performed; if the caller determines not to accept the media type selected by the callee, Step S105 is performed.

In Step S104, if the caller accepts the media type selected by the callee, the media type negotiation between the two parties succeeds, and the session is established successfully.

In Step S105, if the caller does not accept the media type selected by the callee, the caller may continue to initiate a call to negotiate the media type with the callee again; alternatively, the caller may also cancel the session request.

During the development of the present disclosure, the inventors find out at least the following problems in the prior art. According to the existing media negotiation mode, the caller only lists the media types it desires for reference and selection of the callee, such that the preference among the media types offered by the caller is not indicated. Thus, the callee cannot determine the most preferred session mode of the caller among the media types offered by the caller, and may not select the most preferred media type of the caller, resulting in the following three situations: (1) the caller reluctantly accepts the media type selected by the callee; however, as the session does not achieve the effect expected by the caller, the caller may possibly initiate a request for modifying media types during the session to perform new media negotiation, in which the resources will be re-allocated; (2) the caller does not accept the media type selected by the callee, and initiates a request for media negotiation again, which requires extra time for establishing the session; and (3) the caller directly cancels the request for establishing the session with the callee.

### SUMMARY

Accordingly, the present disclosure is directed to a method, a system, and a device for implementing media negotiation, which enables a callee to determine a most preferred media type of a caller during implementation of the media negotiation.

To achieve the above objectives, in an embodiment, the present disclosure provides a method for implementing media negotiation. The method includes the following steps.

A caller sets media levels, and sends a request carrying the media levels to a callee.

The caller receives a response carrying media selected by the callee according to the media levels from the callee, and performs corresponding processing according to the media selected by the callee.

In an embodiment, the present disclosure further provides a terminal, which includes a setting unit, a sending unit, and a processing unit.

The setting unit is adapted to set media levels, and send the media levels to the sending unit.

The sending unit is adapted to send a request carrying the media levels.

The processing unit is adapted to receive a response, and perform corresponding processing according to the selected media in the response.

In an embodiment, the present disclosure further provides a system for implementing media negotiation, which includes a transmission network and an application server.

The transmission network is adapted to receive a request message from a sending party, forward the request message to the matching application server according to SDP parameters carried in the request message, and send the request message to a receiving party according to an address of the receiving party parsed by the application server, such that the receiving party selects media types according to primary media types and optional media types carried in the request message.

The application server is adapted to parse the request message, and check whether the SDP parameters satisfy requirements, and if the SDP parameters satisfy requirements, the application server is adapted to route the parsed request message back to the transmission network.

According to the embodiments of the present disclosure, the caller sets the media levels and specifies the levels of each medium during the media negotiation process. Thus, the additional media level information improves the efficiency of the media negotiation of a session.

### BRIEF DESCRIPTION OF THE DRAWINGS

FIG. 1 is a flow chart of a method for implementing media negotiation in the prior art;

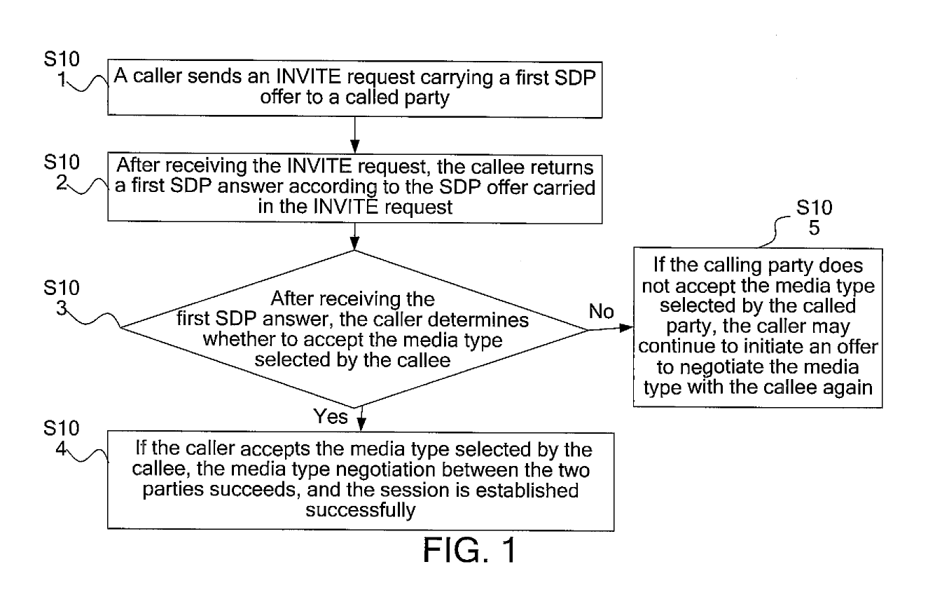

FIG. 2 is a flow chart of a method for implementing media negotiation according to a first embodiment of the present disclosure;

FIG. 3 is a flow chart of a method for implementing media negotiation according to a second embodiment of the present disclosure;

FIG. 4 is a flow chart of a method for implementing media negotiation according to a third embodiment of the present disclosure; and

FIG. 5 is a schematic view of a terminal according to a fourth embodiment of the present disclosure.

### DETAILED DESCRIPTION

The present disclosure provides a method and a device for implementing media negotiation. A caller sets media levels in an SDP message in an initial phase of session establishment, and provides the media levels to a callee for implementing the media negotiation. Thus, the callee knows the most preferred media of the caller, so as to establish a session more efficiently and effectively, and save unnecessary time for media negotiation.

In the embodiments of the present disclosure, the media levels offered by the caller to the callee for media negotiation are implemented through the following two modes.

Mode 1: The media levels include primary media types and optional media types. The primary media types are the most preferred media types of the caller, and are adapted to enable the callee to know the preferred media types of the caller for communication. Thus, the callee can make a selection correspondingly as the preference of the caller is known. The caller conveys the preference among media types during negotiation to the callee by setting the primary media types and the optional media types, in which the optional media types are the supplement and assistance to the primary media types, and help to achieve better session effects.

If it can be estimated that some media types will be used throughout the entire session before the session is established, it is necessary to set these media types to the primary media types. In the case that the caller has special requirements for the media types in the session, the primary media types and optional media types may be set. For example, if the caller intends to perform video and audio communications with the callee at the same time, the video and audio may be both designated as the primary media types. In other scenarios, it is necessary to set the primary media types and optional media types. For example, participants of a video conference must support the video media stream to ensure the normal process of the conference, which is the fundamental condition, so the video stream is designated as the primary media type.

Mode 2: The media levels are represented by priorities corresponding to the media. The higher the priority corresponding to a media is, the higher the media level will be. Thus, the media levels are not limited to the primary media types and optional media types, the caller can set different priorities in sequence according to its preference or conditions, and the callee may select the acceptable media according to the priorities in sequence. Thus, the efficiency of media negotiation is improved.

The specific implementation of the present disclosure will be described in further detail in the following with reference to the accompanying drawings and embodiments.

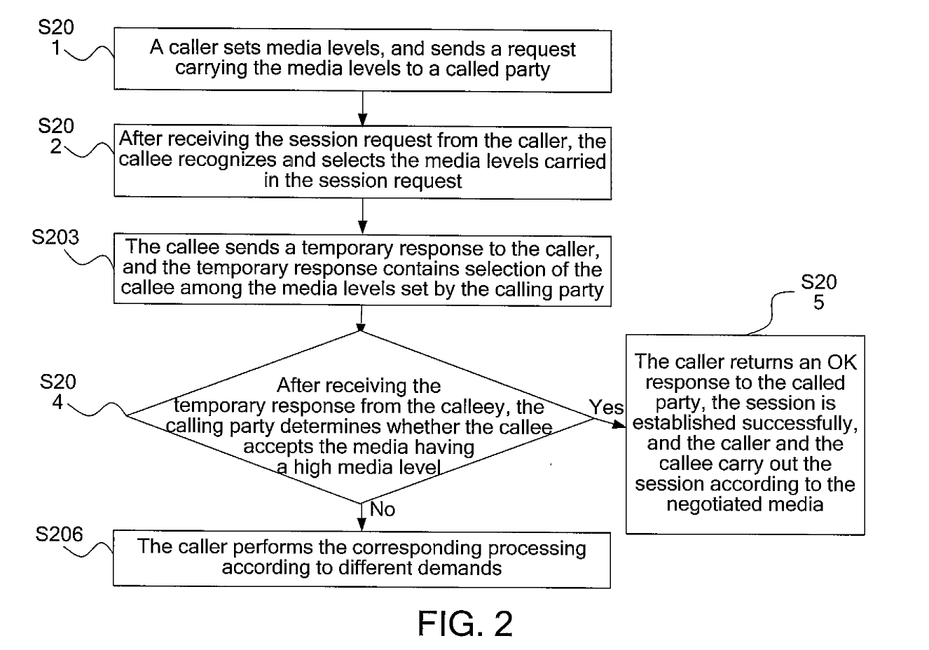

FIG. 2 shows a method for implementing media negotiation according to the first embodiment of the present disclosure. The method includes the following steps.

In Step S201, a caller sets media levels, and sends a request carrying the media levels to a callee. Specifically, the set media levels are carried by extending an SDP message in the session request. There are two modes to set the media levels. The one mode is to set only primary media types and optional media types, and the other mode is to set priorities corresponding to the media to indicate the media levels. The primary media types and optional media types may be set as follows.

The SDP message contains three levels of information, namely, session-level description, time-level description, and media-level description. A media description line belongs to the media-level description. A session description may contain a number of media description lines, and each media description line contains four sub-fields: media type, port number, transmission protocol, and format list. The primary media and optional media may be implemented by extending session-level description attribute lines, media description lines, or allocation of the port numbers in the SDP message.

(1) A session-level attribute line (that is, a primary media and an optional media attribute line) is defined to set the primary media types and optional media types. The primary media and optional media attribute line includes two attribute values, namely, a primary media type and an optional media type.

(2) A primary media and optional media identification sub-field is defined in the media description line to set the primary and optional media types. The primary and optional media identification sub-field is defined in the media description, so as to indicate whether the media type in the media description line is the primary media type or the optional media type.

Further, when one media type is corresponding to a number of media description lines (that is, a number of media streams of the same type), the primary media and optional media identification sub-field can be used to indicate whether a media stream is the primary media type or the optional media type.

(3) A session-level attribute line, namely, a primary media port number attribute line, is defined. The primary media port number attribute line specifies port numbers corresponding to all primary media types in their respective media description lines. That is to say, if a port number value corresponding to the primary media port number attribute line is 51372, the media corresponding to the port (51372) is the primary media type. The port number is a destination port number (that is, a port number of the callee) for sending the media, and is determined by network information and the transmission protocol.

Further, the extending method is not applicable to the situation that IP addresses are different but the port numbers are the same, but is applicable to the situation that the SDP message contains only a session-level connection state line.

Further, when multiple ports are set in one media line, all the port numbers should be listed in the primary media port number attribute line.

Further, as the port numbers are corresponding to the media types in the media description lines, when one media type is corresponding to a number of media description lines (that is, a number of media streams of the same type), the primary media port number attribute line can be used to indicate whether a media stream is the primary media type or the optional media type.

The media priorities may be set by defining a media-level attribute line, that is, a media priority attribute line, so as to specify the priority of a media type. The caller assigns priorities to different media types that it intends to use in the session, so as to set the media levels.

In Step S202, after receiving the session request from the caller, the callee recognizes and selects the media levels carried in the session request.

In Step S203, the callee sends a temporary response to the caller, and the temporary response contains selection of the callee among the media levels set by the caller.

In Step S204, after receiving the temporary response from the callee, the caller determines whether the callee accepts the media with a high media level; if the callee accepts the media with a high media level, Step S205 is performed; if the callee does not accept the media with a high media level, Step S206 is performed.

In Step S205, if the callee accepts the media with the high level set by the caller, the caller returns an OK response to the callee, the session is established successfully, and the caller and the callee carry out the session according to the negotiated media.

In Step S206, if the callee does not accept the media with the high level set by the caller, the caller performs the corresponding processing according to different demands:

(1) The OK response is returned, the session is established successfully, and the caller and the callee carry out the session according to the negotiated media.

(2) The caller resets the media levels, and continues media negotiation with the callee.

(3) The caller cancels the session connection establishment with the callee.

The session in the above steps may be a one-to-one Converged IP Message (CPM) multimedia session, or a CPM multimedia predefined group session. Then, the present disclosure is described as follows with specific embodiments respectively. In order to make the present disclosure more comprehensible, in this embodiment, the primary media types and optional media types generated in Mode 1 are described. The process in which the priority mode is adopted is similar to the process in which the primary and optional media mode is adapted, and will not be described again here.

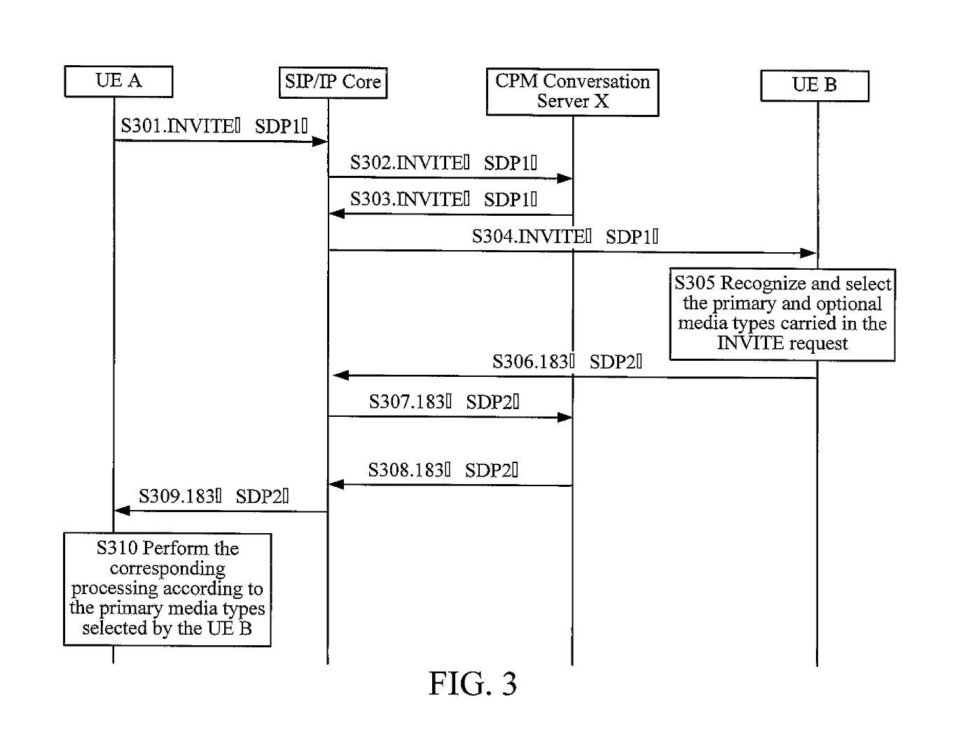

In the second embodiment of the present disclosure, the one-to-one CPM multimedia session is taken for example. Definitely, the present disclosure is not limited to the CPM multimedia session, and the CPM is only a specific service application. FIG. 3 shows a method for implementing media negotiation. The method includes the following steps.

In Step S301, a user equipment (UE) A sets primary media types and optional media types, and sends an INVITE message carrying the primary media types and optional media types to a UE B.

Specifically, a user A and a user B are both CPM subscribers, and are in the same home network and the same domain. The primary media types and optional media types can be set when the session is established by extending the session-level attribute line a, media description line m, and allocation of port numbers in the SDP message, so as to carry out the media negotiation.

(1) The session-level attribute a is defined to implement the media negotiation. The session-level attribute of the SDP message is defined as follows:

Inviting-mediatypes=a=nviting:primary-types SP optional-types

in which

primary-types=(“audio”|“video”|“application”|“message”|“text”)

optional-types=(“audio”|“video”|“application”|“message”|“text”|“none”)

Here, Inviting-media types indicates all media types that the UE A can provide, in which primary-types and optional-types indicate the primary media types and the optional media types designated by the UE A respectively.

Further, the SDP message in the INVITE request is as shown as follows, in which a=inviting:video indicating that the video is specified as the primary media type.

v=0

o=Alice 2890844526 2890842807 IN IN 10.47.16.5

s=My holiday

i=Pictures of my holiday

e=Alice@example.com (Alice)

c=IN IP4 10.47.16. 5

t=2873397496 2873404696

a=inviting:video

a=sendrecv

m=audio 49170 RTP/AVP 0

m=video 51372 RTP/AVP 99

a=rtpmap:99 h263-1998/90000

Here, an example of the primary media types is described in the above embodiment. In this example, the first to sixth lines are session description, that is, line v indicates the protocol version, line o indicates the owner/creator and session identification, line indicates the session name, line i indicates the session information, line e indicates the Email address, and line c indicates the connection information, which is not needed when being contained in all media. The seventh line is time description, that is, line t indicates the start and stop times for a session. The eighth to twelfth lines are media description, that is, line m indicate the media name and transmission addresse, and line a indicates zero or multiple session attribute lines.

(2) The media description line m is extended to implement the media negotiation. Line m carries the media and transmission information, including the media type (for example, audio or video), destination port number for sending the media, transmission protocol, and format list. The grammar of line m is as follows:

m=<media> <port> <transport> <fmt list>

In this embodiment, an identification type-tag is added to line m to indicate whether the media type in each line m is the primary media type or the optional media type, that is:

m=<media> <port> <transport> <fmt list> <type-tag>

in which type-tag=(“primary”|“optional”), that is, primary and optional indicate the media type in the media line is the primary media and the optional media respectively.

Further, the SDP message in the INVITE request is as shown as follows, in which the video is the primary media type, and the audio is the optional media type.

v=0

o=Alice 2890844526 2890842807 IN IP4 10.47.16.5

s=My holiday

i=Pictures of my holiday

e=Alice@example.com (Alice)

c=IN4 IP4 10.47.16. 5

t=2873397496 2873404696

a=sendrecv

m=audio 49170 RTP/AVP 0 optional

m=video 51372 RTP/AVP 99 primary

a=rtpmap:99 h263-1998/90000

(3) The allocation of port numbers is defined to implement the media negotiation. As described above, in the media line m=<media> <port> <transport> <fmt list>, port indicates the destination port number for sending the media. In order to make the UE B identify the primary media and optional media among all the media types in line m, the following session-level attribute is defined:

Primary-ports=a=port: <primary media port number>

That is to say, the primary media port number specifies port numbers corresponding to the primary media types among all media types contained in line m.

Further, the SDP message in the INVITE request is as shown as follows, in which a=port:51372 indicates that the video corresponding to the port number 51372 is specified as the primary media type.

v=0

o=Alice 2890844526 2890842807 IN IP4 10.47.16.5

s=My holiday

i=Pictures of my holiday

e=Alice@example.com (Alice)

c=IN IP4 10.47.16. 5

t=2873397496 2873404696

a=port:51372

a=sendrecv

m=audio 49170 RTP/AVP 0

m=video 51372 RTP/AVP 99

a=rtpmap:99 h263-1998/90000

It should be noted that if the preference among the media types is declared by setting the priorities in this embodiment, the details are as follows.

The following media-level attribute is defined to set the priorities of each media type:

Media-pri=a=pri:privalue in which privalue=(“inessential”|“non-urgent”|“normal”|“urgent”|“emergency”)

Here, privalue indicates the priority value of a media type, and the five values are corresponding to an ascending priority order from inessential to emergency. In this embodiment, the five values are defined to be corresponding to five media types.

Further, the SDP message in the INVITE request is as shown as follows, in which a=pri:emergency indicates that the audio stream has the highest priority, and a=pri:normal indicates that the video stream has the normal priority.

v=0

o=Alice 2890844526 2890842807 IN IP4 10.47.16.5

s=My holiday

i=Pictures of my holiday

e=Alice@example.com (Alice)

c=IN IP4 10.47.16. 5

t=2873397496 2873404696

a=sendrecv

m=audio 49170 RTP/AVP 0

a=pri:emergency

m=video 51372 RTP/AVP 99

a=rtpmap:99 h263-1998/90000

a=pri:normal

In Step S302, as an operator often defines user configurations for different users in the network, for example, the media configuration, which includes the SDP parameters, after receiving the INVITE request, an SIP/IP Core checks whether the SDP parameter setting of the UE is within the scope of the media types allowed by the operator; if the SDP parameter setting of the UE A is within the scope of the media types allowed by the operator, the SIP/IP Core sends the INVITE request to a CPM Conversation Server X; if the SDP parameter setting of the UE A is not within the scope of the media types allowed by the operator, the SIP/IP Core sends a 415 answer to the UE A.

Specifically, the SIP/IP Core checks initial filter criteria of an application server related to the user A in the network one by one. When finding that the information in the INVITE request matches the CPM Conversation Server X, the SIP/IP Core sends the INVITE request to the CPM Conversation Server X.

In Step S303, the CPM Conversation Server X parses the received INVITE request. As the policy of a service provider (SP) and user's personal favorite setting may include limitations on the media, the CPM Conversation Server X checks whether the SDP parameters in the INVITE request of the user A satisfies the requirements according to the limitation information; if the SDP parameters in the INVITE request of the user A satisfies the requirements, the CPM Conversation Server X routes the INVITE request back to the SIP/IP Core; if the SDP parameters in the INVITE request of the user A does not satisfy the requirements, a possible operation is that the CPM Conversation Server X sends the 415 answer to the UE.

In Step S304, the SIP/IP Core sends the INVITE request to the UE B according to a parsed address of the UE B.

In Step S305, after receiving the INVITE request, the UE B recognizes the primary media types and optional media types carried in the INVITE request, and selects the media types.

In Step S306, the UE B sends a 183 response to the UE A. The 183 response contains the selection of the UE B among the primary media types and optional media types set by the UE A.

Here, the UE B sets the port number to zero in the media description line corresponding to the rejected media type in the 183 response.

In Step S307, as an operator often defines user configurations for different users in the network, for example, the media configuration, which includes the SDP parameters, after receiving the 183 response, the SIP/IP Core checks whether the SDP parameter setting in the 183 response sent by the UE B is within the scope of media types allowed by the operator; if the SDP parameter setting in the 183 response sent by the UE B is within the scope of media types allowed by the operator, the SIP/IP Core routes the 183 response to the CPM Conversation Server X through the 183 response; if the SDP parameter setting in the 183 response sent by the UE B is not within the scope of media types allowed by the operator, the SIP/IP Core sends a 415 answer to the UE B.

In Step S308, after the CPM Conversation Server X receives the 183 response, as the policy of the SP and the personal favorite setting may include limitations on the media, the CPM Conversation Server X checks whether the SDP parameters in the response of the user B satisfy the requirements by using the limitation information; if the SDP parameters in the response of the user B satisfy the requirements, the CPM Conversation Server X routes the INVITE request back to the SIP/IP Core according to a Via field in the 183 response; if the SDP parameters in the response of the user B do not satisfy the requirements, a possible operation is to send the 415 answer to the UE B by the CPM Conversation Server X.

In Step S309, the SIP/IP Core sends the 183 response to the UE A according to the Via field.

In Step S310, the UE A performs the corresponding processing according to the primary media types selected by the UE B.

Specifically, according to the primary media types selected by the UE B, the UE A performs the following processing:

(1) If the UE A accepts the media types selected by the UE B, the UE A sends a 200 OK response to the UE B, the media negotiation succeeds, and the two parties carry out the session according to the negotiated media types.

(2) If the UE A does not accept the media types selected by the UE B, the UE A may cancel the INVITE request, or sets the primary media types and optional media types again for another media negotiation with the UE B, or returns the 200 OK to carry out the session with the UE B.

Definitely, the SIP/IP Core in the embodiment of the present disclosure may also be other transmission networks, as long as they can implement the functions of the SIP/IP Core. Moreover, the CPM Conversation Server X in the embodiment of the present disclosure may also be other application servers, which may be selected according to actual applications.

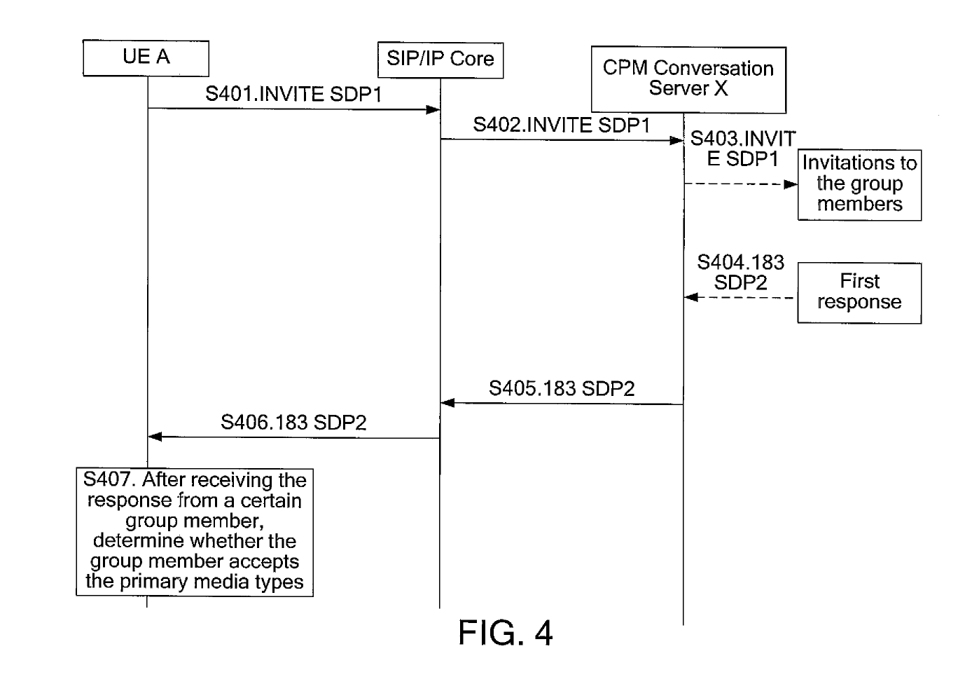

In the third embodiment of the present disclosure, a CPM multimedia predefined group session is taken for example. FIG. 4 shows a method for implementing media negotiation, which includes the following steps.

In Step S401, a UE A sets primary and optional media types, and sends an INVITE request to an address of a predefined group. The INVITE request contains information about the predefined group and the set primary and optional media types.

Specifically, the UE A is a CPM user, and is a creator of the group or an authorized user of the group. The primary and optional media types or priorities can be set according to the method described in the second embodiment, which will not be described again here.

In Step S402, as the operator often defines user configurations for different users in the network, for example, the media configuration, which includes the SDP parameters, after receiving the INVITE request, an SIP/IP Core checks whether the SDP parameter setting of the UE A is within the scope of media types allowed by the operator; if the SDP parameter setting of the UE A is within the scope of media types allowed by the operator, the SIP/IP Core sends the INVITE request to a CPM Conversation Server X; if the SDP parameter setting of the UE A is not within the scope of media types allowed by the operator, the SIP/IP Core sends a 415 answer to the UE A.

Specifically, the SIP/IP Core checks initial filter criteria of an application server related to the user A in the network one by one. When finding the information in the INVITE request matches the CPM Conversation Server X, the SIP/IP Core sends the INVITE request to the CPM Conversation Server X.

In Step S903, the CPM Conversation Server X parses the received INVITE request. As the policy of an SP, personal favorite setting, and group session rules may include limitations on the media, the CPM Conversation Server X checks whether the SDP parameters in the group session request satisfy the requirements; if the SDP parameters in the group session request satisfy the requirements, the CPM Conversation Server X routes the INVITE request back to the SIP/IP Core; if the SDP parameters in the group session request do not satisfy the requirements, a possible operation is to send a 415 answer to the UE A by the CPM Conversation Server X. Moreover, a request for obtaining a group member list may be sent to a storage device according to the information about the group contained in the request message, and the obtained group member list is parsed, and then a group session request is sent to other group members according to the parsing result. Here, the storage device is a server storing files and data related to specific services or public information common to multiple services. Specifically, the storage device is an Extensible Markup Language (XML) Document Management Server (XDMS), in which the XML is an extensible markup language.

In Step S404, after receiving the INVITE request, other group members select from among the primary and optional media types, and each returns a temporary response, that is, a 183 response, to the CPM Conversation Server X.

In Step S405, the CPM Conversation Server X sends the response to SIP/IP Core according to a Via field in the 183 response, and the response returned by each group member contains its selection of the primary media and optional media.

In Step S406, the SIP/IP Core sends the response to the UE A according to the Via field in the 183 response.

In Step S407, after receiving the response of a certain group member, the UE A determines whether the group member accepts the primary media types; if the group member accepts the primary media types, the UE A allows the group member to join the group session; if the group member does not accept the primary media types, the UE A sends a CANCEL message to cancel the session request.

Preferably, in the above three embodiments, the caller can modify the media levels sent to the callee through a re-INVITE request during the session. Next, an example in which the primary and optional media types are set is taken in the following description. It should be noted that though the media levels are set only by the caller in the above embodiments, the party for setting the media levels in the session (the caller or the callee) is not limited according to the embodiments of the present disclosure. During the session, both parties of the session can reset the desired media levels according to their requirements.

A re-INVITE request containing new media attribute description can be sent to update the media that have been sent to the other party. The re-INVITE request also declares the primary media types and optional media types through the above three solutions. The re-INVITE request is bundled to an existing session. After receiving the re-INVITE request, the other party sends a 200 (OK) answer, indicating that the update is accepted. The requesting party sends an ACK, indicating that the 200 (OK) answer sent by the other party is accepted. If the other party does not agree with the media attribute change, the other party returns an error answer, for example, 488 (the change is not allowed temporarily). The initiator sends an ACK response to the error answer. The re-INVITE negotiation result does not affect the existing session, that is, the existing session continues according to the original media attributes.

Through the methods provided in the embodiments of the present disclosure, the caller sets the primary media types and optional media types and specifies the levels of each media type during the media negotiation. Thus, the additional media level information improves the efficiency of the media negotiation of a session.

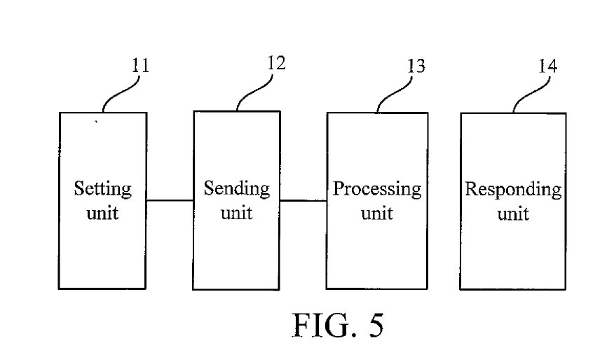

FIG. 5 shows a terminal according to the fourth embodiment of the present disclosure. As shown in FIG. 5, the terminal includes a setting unit 11, a sending unit 12, and a processing unit 13.

The setting unit 11 is adapted to set media levels, and send the media levels to the sending unit 12.

The sending unit 12 is adapted to send a session request carrying the media levels to a callee. Specifically, the media levels set by the setting unit 11 are carried by extending an SDP message in the session request.

The processing unit 13 is adapted to receive a session response sent by the callee, and perform corresponding processing according to the media levels selected by the callee.

In addition, the terminal further includes a responding unit 14.

The responding unit 14 is adapted to respond to the session request carrying the media levels, and return the selected media in the session response.

Specifically, the method for carrying the set media levels by extending the SDP message in the session request is that described in the first embodiment, and will not be described again here.

Through the system provided in the embodiment of the present disclosure, the caller sets the primary and optional media types and specifies the levels of each media types during the media negotiation. Thus, the additional media level information improves the efficiency of the media negotiation of a session.

In an embodiment, the present disclosure further provides a system for implementing media negotiation, which includes a transmission network and an application server. The transmission network is adapted to receive a request message from a sender, forward the request message to the matching application server according to SDP parameters carried in the request message, and send the request message to a receiving party according to the address of the receiver parsed by the application server, such that the receiving party selects media types according to primary media types and optional media types carried in the request message. The application server is adapted to parse the request message, check whether the SDP parameters satisfy requirements, and if the SDP parameters satisfy requirements, the application server is adapted to route the parsed request message back to the transmission network.

Through the above description of the implementation, it is clear to persons skilled in the art that the present disclosure may be accomplished through hardware, or through software plus a necessary universal hardware platform. Based on this, the above technical solution or the part that makes contributions to the prior art can be substantially embodied in the form of a software product. The computer software product may be stored in a computer readable storage medium, and contain several instructions to instruct computer equipment to perform the method described in the embodiments of the present disclosure.

Several specific embodiments of the present disclosure are disclosed herein. However, the present disclosure is not limited to the embodiments, and any modification that can be thought of by persons skilled in the art shall fall within the protective scope of the present disclosure.

What is claimed is:

1. A method for implementing media negotiation, the method comprising:
setting, by a caller, media levels, and sending a request carrying the media levels to a callee; and
receiving, by the caller, a response carrying media selected by the callee according to the media levels returned from the callee, and
performing corresponding processing according to the media selected by the callee.

2. The method for implementing media negotiation according to claim 1, wherein the sending, by the caller, the request carrying the media levels to the callee comprises:
carrying, by the caller, the set media levels in a Session Description Protocol (SDP) message in the request.

3. The method for implementing media negotiation according to claim 2, wherein the media levels comprise primary media types and optional media types, and the levels of the primary media types are higher than the levels of the optional media types.

4. The method for implementing media negotiation according to claim 3, wherein the carrying the primary media types and the optional media types in the SDP message comprises:
defining a primary media and optional media attribute line carrying the set primary media types and optional media types in the SDP message, wherein the primary media and optional media attribute line comprises two attribute values which are the primary media type and the optional media type.

5. The method for implementing media negotiation according to claim 3, wherein the carrying the primary media types and the optional media types in the SDP message comprises:
defining a primary media and optional media identification sub-field carrying the set primary media types and optional media types in a media description line of the SDP message.

6. The method for implementing media negotiation according to claim 3, wherein the carrying the primary media types and the optional media types in the SDP message comprises:
defining a primary media port number attribute line in the SDP message, wherein a media corresponding to a port number value carried in the primary media port number attribute line is the primary media type, and other media is the optional media type.

7. The method for implementing media negotiation according to claim 6, further comprising listing all the port numbers in the primary media port number attribute line when a number of ports is set in a media description line.

8. The method for implementing media negotiation according to claim 2, wherein the media levels are represented by priorities corresponding to the media, and the media with the high priority corresponds to the high media level, and the carrying, by the caller, the set media levels by extending the SDP message in the request comprises:
defining a media priority attribute line carrying the set media levels, wherein the media priority attribute line specifies the priority of a certain media type.

9. The method for implementing media negotiation according to claim 1, wherein the receiving, by the caller, the response carrying the media selected by the callee according to the media levels returned from the callee, and the performing the corresponding processing according to the media selected by the callee comprises:
returning, by the caller, the response message, establishing a session successfully, and carrying out, by the caller and the callee, the session according to the media negotiated with the callee; or
resetting, by the caller, the media levels, and continuing the media negotiation with the callee; or
canceling, by the caller, session connection establishment with the callee.

10. The method for implementing media negotiation according to claim 1, wherein the receiving, by the caller, the response carrying the media selected by the callee according to the media levels returned from the callee, and the performing the corresponding processing according to the media selected by the callee comprises:
resetting, by the caller, the media levels, and continuing the media negotiation with the callee.

11. The method for implementing media negotiation according to claim 1, wherein the receiving, by the caller, the response carrying the media selected by the callee according to the media levels returned from the callee, and the performing the corresponding processing according to the media selected by the callee comprises:
canceling, by the caller, session connection establishment with the callee.

12. The method for implementing media negotiation according to claim 1, further comprising:
updating the media levels sent to another party of a session through new media levels carried in a re-INVITE request.

13. A terminal comprising:
a setting unit;
a sending unit;
a processing unit; and wherein:
the setting unit is adapted to set media levels, and send the media levels to the sending unit;
the sending unit is adapted to send a request carrying the media levels; and
the processing unit is adapted to receive a response, and perform corresponding processing according to the selected media in the response.

14. The terminal according to claim 13, further comprising:
a responding unit, adapted to respond to the request carrying the media levels, and return the selected media in the response.

15. A system for implementing media negotiation, the system comprising a transmission network and an application server, and wherein the transmission network is adapted to receive a request message of a sending party, forward the request message to a matching application server according to Session Description Protocol (SDP) parameters carried in the request message, and send the request message to a receiving party according to an address of the receiving party parsed by the application server, wherein the receiving party selects media types according to primary and optional media types carried in the request message; and
the application server is adapted to parse the request message, and check whether the SDP parameters satisfy requirements, and if the SDP parameters satisfy requirements, the application server is adapted to route the parsed request message back to the transmission network.

16. A computer program product, comprising computer program code, which, when executed by a computer unit, causes the computer unit to perform the processes of claim 1.
